(19) United States
(12) Patent Application Publication
(10) Pub. No.: US 2022/0407260 A1
(43) Pub. Date: Dec. 22, 2022

(54) ELECTRIC HOUSEHOLD APPLIANCE WITH TOUCH PROTECTION FOR ELECTRICAL CONTACTS

(71) Applicant: Vorwerk & Co. Interholding GmbH, Wuppertal (DE)

(72) Inventors: Philipp Charopoulos, Ratingen (DE); Sebastian Jansen, Bochum (DE); Stephan Pohl, Wuppertal (DE)

(21) Appl. No.: 17/728,504

(22) Filed: Apr. 25, 2022

(30) Foreign Application Priority Data
Jun. 18, 2021 (DE) 102021206293

(51) Int. Cl. H01R 13/44; H01R 13/502; H01R 24/76; H01R 13/66

(52) U.S. Cl. CPC H01R 13/44; H01R 13/502; H01R 24/76; H01R 13/665; H01R 2201/00

(57) ABSTRACT

An electrical household appliance includes electrical contacts. The electrical household appliance includes accesses to the electrical contacts for establishing an electrical plug connection.

### CROSS-REFERENCE TO RELATED APPLICATION

This application claims benefit of priority to German Patent Application No. 102021206293, filed Jun. 18, 2021, the disclosure of which is hereby incorporated in its entirety by reference herein.

### TECHNICAL FIELD

The present disclosure relates to an electrical household appliance with touch protection for electrical contacts.

### BACKGROUND

There is an electric household appliance called Thermomix Friend®. This household appliance is the subject of the European patent application with the official file number 20175328.2. The household appliance Thermomix Friend® comprises a stand part and a vessel with a stirring tool located inside. The vessel can be inserted into the stand part. The vessel comprises an electrical heating device and electrical plugs connected to the heating device. The electrical plugs protrude downward from the vessel bottom. The stand part comprises electrical sockets into which the electrical plugs of the vessel are inserted when the vessel is inserted into the stand part. The electrical heating device may then be supplied with power for heating via the stand part. The present disclosure also relates to such an electrical household appliance.

### SUMMARY

The present disclosure seeks to protect such electrical sockets, i.e., electrical contacts, from unintentional touching.

The electrical appliance is in particular an electrical household appliance. The electrical appliance comprises electrical contacts and an access to the electrical contacts for establishing an electrical plug connection. There is an electrical insulation which protects against touching the electrical contacts. There are at least two bolts as part of the electrical insulation. In an electrically insulating position, the bolts are passed through the electrical contacts. The bolts can be moved independently of each other. The bolts can be moved from the electrically insulating position to an electrically non-insulating position only when the two bolts are moved together.

### BRIEF DESCRIPTION OF DRAWINGS

FIG. 1 illustrates electrical contacts with touch protection in electrically insulating initial position;

FIG. 2 illustrates electrical contacts with a single-lowered contact protection;

FIG. 3 illustrates electrical contacts with a double-lowered contact protection;

FIG. 4 illustrates rocker;

FIG. 5 illustrates rocker and bolts;

FIG. 6 illustrates a cut view of an exemplary embodiment with electrical contacts;

FIG. 7 illustrates electrical contacts and bolts connected in pairs; and

FIG. 8 illustrates a mixer.

### DETAILED DESCRIPTION

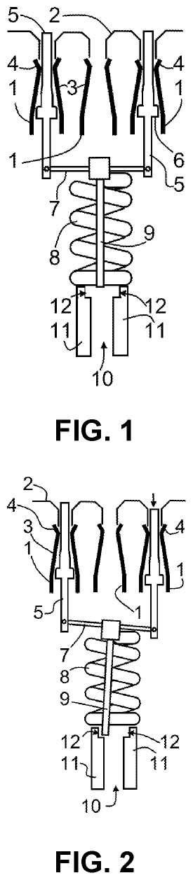

FIG. 1 shows electrical contacts 1 of a stand part. The electrical contacts 1 are configured such that they can be connected to electrical contacts projecting downward from the base of a vessel. The electrical contacts are three electrical sockets 1 consisting of metal, which are held by a housing part 2 of the stand part consisting of plastic, which is only partially shown. Each electrical socket 1 has an upwardly tapering, clip-like base part 3. The opposing arms of the base part 3 can be elastically bent. Each base part 3 is adjoined at the top by an enlargement 4, through which insertion of an electrical plug is facilitated. The enlargement 4 can be formed by platelets at the upper end of arms. At the upper side, each enlargement 4 adjoins the housing part 2 which consists of plastic, so that the housing part 2 contributes to protect against accidental touching of the electrical sockets 1. The electrical contacts 1 are also covered laterally and on their underside by components consisting of plastic, and are thus protected from accidental touching. The electrical contacts 1 can be crimp contacts.

The center electrical socket 1 is a protective earth contact. Therefore, no additional measures are required to protect against touching the middle electrical socket 1.

The two outer electrical sockets 1 are current-carrying and therefore equipped with a separate touching protection. Each touching protection for the two outer electrical sockets 1 comprises a bolt 5 consisting of plastic. Each bolt 5 is passed through a current-carrying electrical socket 1 and protrudes from the associated socket 1 both on the upper side and on the lower side. At the upper side, the bolt 5 protects against accidental touching of the associated electrical contact 1. Each bolt 5 comprises a widening 6. The widening 6 is located within the upwardly tapering base part 3 in the initial position shown in FIG. 1.

The lower ends of the two bolts 1 are connected to each other by a rocker 7 or at least rest on the upper side of the rocker 7. The ends of the rocker 7 can be pivotably connected to the lower ends of the bolts 5, or the lower ends of the two bolts 1 can rest on ends of the rocker 7. The rocker 7 can therefore be pivoted. There is such a contact between rocker 7 and bolts 5 that the rocker 7 can press the bolts 5 upwards and the rocker 7 can be pivoted by moving a bolt 5. In addition, the rocker 7 can be lowered by the two bolts 5.

A preloaded spring 8 presses against the underside of the rocker 7. By means of the spring 8 and the rocker 7, the widenings 6 of the bolts 5 are pressed against the upwardly tapering base part 3. Through this, the bolts 1 are held in their initial position as shown in FIG. 1.

A rod 9 projects vertically downwards from the rocker 7. The rod 9 is arranged in a central region of the rocker 7. The lower end of the rod 9 is located above an intermediate space 10, which is bounded by two boundaries 11. The upper sides of the boundaries 11 have opposing steps 12. The steps 12 comprise a horizontally extending blocking surface and a surface projecting upwardly from the blocking surface, generally vertically.

FIG. 2 shows a bolt 5 on the right-hand side which has been pressed down against the force of the spring 8 compared to FIG. 1. Since the bolt 5 shown on the left is still in its initial electrically insulating position, the rocker 7 has been pivoted downward on the right. The rod 9 has thus been pivoted into the step 12 shown on the left. Therefore, the bolt 5 shown on the right cannot be moved further down. The electrical socket 1 shown on the right cannot be touched because this is prevented by the still upwardly projecting bolt 5 and the housing part 2 adjacent to it, which continue to shield the electrical socket 5 shown on the right towards the outside. The bolt 5 shown on the right cannot therefore be moved out of its electrically insulating position.

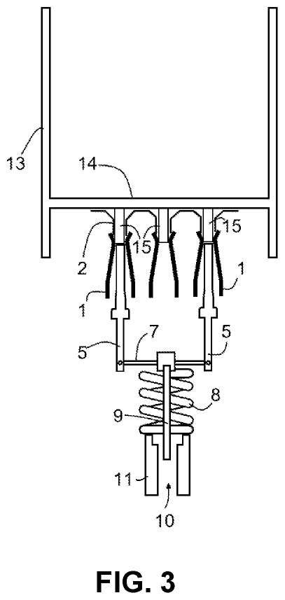

FIG. 3 shows a sectional sketch of a vessel 13 with a bottom 14. Electrical plugs 15 protrude downward from the bottom 14. The vessel 13 is inserted into a recess 16 in the stand part. The recess 16 can be integrally connected to the housing part 2. However, the recess 16 can also be a separate part from the housing part 2. The electrical plugs 15 have simultaneously pressed the bolts 5 down. Therefore, the rocker 7 has only been lowered against the force of the spring 8, but not pivoted. The rod 9 was therefore not pivoted into a step 12. The rocker 7 could therefore be lowered such that the plugs 15 made electrical contact with the sockets 1 as shown in FIG. 3.

Thus, FIGS. 1 to 3 show electrical contacts 1 of a household appliance with an access for electrical contacts 15 of a vessel 13 for establishing an electrical plug connection. There is an electrical insulation 2, 5, which protects against touching of the electrical contacts 1. Two bolts 5 are part of the electrical insulation. The bolts 5 can be moved from an electrically insulating position to an electrically non-insulating position only if the two bolts 5 are moved together.

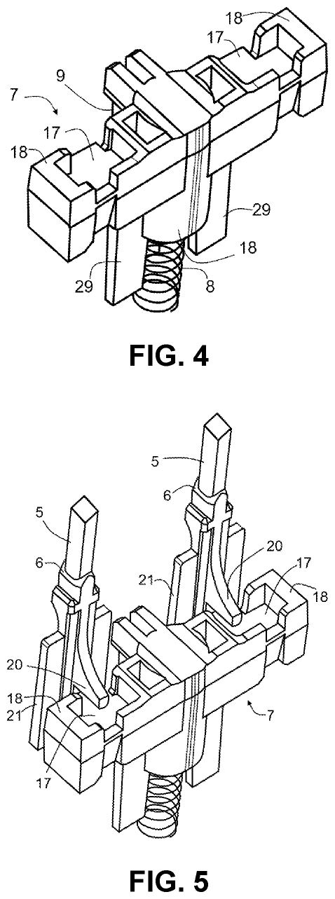

In FIG. 4, a preferred exemplary embodiment of the rocker 7 is shown. This comprises two bearing surfaces 17. The bearing surfaces 17 have a partial edging 18. The rod 9 is arranged laterally of the rocker 7 and integrally connected to a central region of the rocker 7. The rod 9 has thus been produced in one step together with the rocker 7, for example by plastic injection molding. One end of the spring 8 extends into a cylindrical recess 19 of the rocker 7. The cylindrical recess 19 is open at the bottom.

The rocker 7 may, for example, have two further downwardly extending rods 29, which, however, may be arranged such that they cannot extend into a step 12 for blocking. Instead, the further rods 29 can be guided, for example, by holding rails to stabilize the position of the rocker 7.

In FIG. 5, the rocker 7 is shown together with an embodiment of two bolts 5. Projections 20 of the bolts 5 rest on the bearing surfaces 17 of the rocker 7 and extend into the edgings 18. Each edging 18 of the rocker 7 therefore contributes to securing the position of the bolts 5. If one bolt 5 is pressed down, it presses down the bearing surface 17 of the rocker 7. If both bolts 5 are pressed down simultaneously, the rocker 7 is lowered. If only one bolt 4 is pressed down, only one end area of the rocker 7 is lowered and the rocker 7 is therefore pivoted. The bolts can be moved back to their initial position by the force of spring 8.

The bolts 5 are integrally connected to a plate 21 on their underside. The plate 21 serves to guide the bolt 5 so that it can be reliably moved up and down.

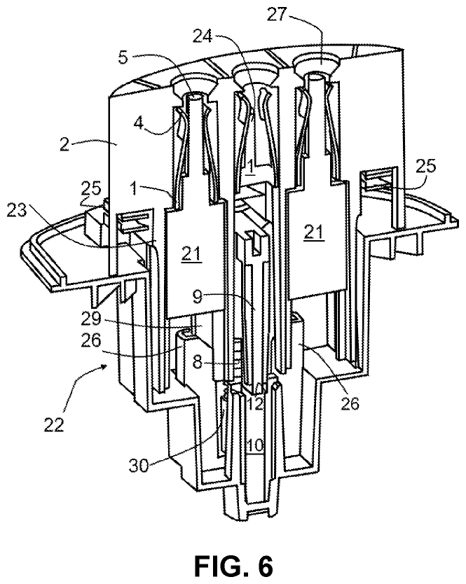

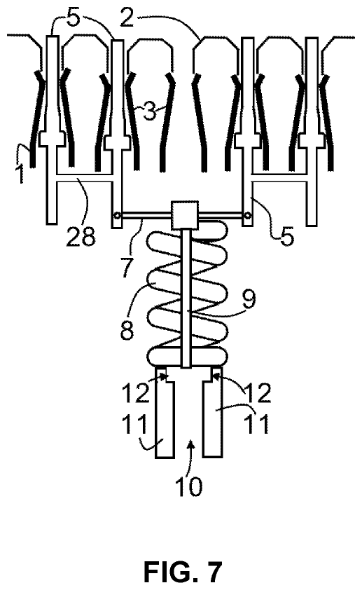

FIG. 6 shows an embodiment in the cut-away state with the bolts 5 of FIG. 5 and the rocker 7 of FIGS. 4 and 5. A half-shell 22 consisting of plastic on the underside comprises the steps 12 and the intermediate space 10 for the rod 9. In addition, the half-shell 22 can hold the underside of the spring 8. The half-shell 22 may have holding rails 26, which are U-shaped in section, for the rods 29 of the rocker 7. The holding rails surround the rods 29 at such a distance that a desired pivoting movement of the rocker 7 is not prevented by the holding rails 26. The half-shell 22 comprises a cylindrical holder 30 for holding the lower end of the spring 8. A housing part 2 sits on the upper side of the half-shell 22. The housing part 2 comprises guide rails 23 for the plates 21. FIG. 6 illustrates that each socket 1 may comprise, in addition to two arms with the enlargements 4, a further arm 24 for electrically contacting. The further arm 24 may be rearwardly offset as shown in FIG. 6 and otherwise disposed between the two arms forming the enlargements 4. The electrical sockets 1 are held in place by the housing part 2. The electrical contacts may each have a lateral connection 25. The lateral connections may be connected to a power source via further electrical conductors. The housing part 2 has funnel-shaped inlet openings 27 on the upper side above the sockets 1 for easy insertion of electrical plugs 15.

FIG. 7 shows an example with five contacts 1. Four of the five contacts are current-carrying contacts. Therefore, bolts 5 are passed through four contacts 1. The bolts 5 are connected to each other in pairs by, for example, a rod-shaped connecting element 28. The connecting elements 28 are located below the contacts 1. Each pair of bolts 5 behaves like a single bolt 5 from FIG. 1. If only bolt 5 and thus only one pair of bolts is pressed down, this movement is blocked as soon as the rod 9 has been pivoted into a step 12. If both pairs of bolts are pressed down at the same time, i.e., together, the rod 9 is not pivoted into a step 12 and the electrical contacts 1 can be electrically contacted by electrical plugs.

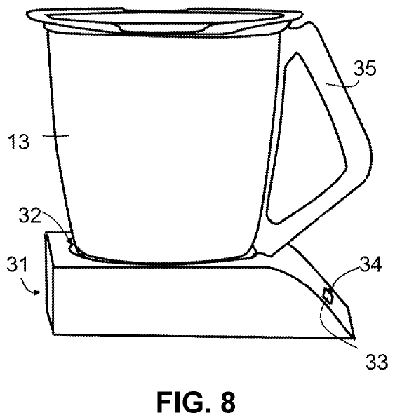

FIG. 8 shows a mixer with a stand part 31 and a vessel 13, which is inserted into a recess 32 of the stand part 31. The stand part is equipped with a display 33 and a rotary knob 34. The vessel 13 can be removed from the recess 32 by means of the handle 35. The vessel 13 and the stand part 31 are electrically connected to each other via a plug connection, as shown in FIG. 3.

An electrical appliance is a device that requires electrical power for its operation. The electrical appliance may comprise an electric motor. The electrical appliance may comprise an electronic control. The electrical appliance may comprise an input device for operating electrical components of the electrical appliance. The electrical appliance may comprise a switch as an input device. The electrical appliance may comprise a touch-sensitive display as an input device. The electrical appliance may comprise a microphone and voice recognition as an input device.

The electrical appliance may comprise an output device in order to be able to output information, for example, on the operation of the electrical appliance. A display may be provided as an output device. A loudspeaker may be provided as an output device.

The electrical appliance may comprise a battery to be supplied with power. The electrical appliance may comprise a cable and a plug that can be connected to an external electrical power source to provide electrical power to the electrical appliance.

If the electrical appliance is a household appliance, it is an appliance that is designed and suitable for use in a private household. For example, it may be a food processor with which a food can be prepared.

The electrical contacts are designed and suitable to be connected to other electrical contacts. There is therefore an access to each electrical contact. Through the accesses, the electrical contacts can be electrically contacted by other electrical contacts.

There is an electrical insulation that protects against touching the electrical contacts. The electrical insulation consists in particular of plastic. The electrical insulation covers the electrical contacts in particular so completely that the electrical contacts can no longer be reached with the finger of a normal-sized hand of an adult person and/or a child. The access leading to an electrical contact therefore has a diameter of no more than 5 mm at its narrowest point, for example, so that even a finger of a child cannot touch the electrical contact.

A bolt is an elongated object that can extend through an electrical contact. A bolt is at least substantially pin-shaped. Because a bolt is part of the electrical insulation, the bolt consists of an electrically insulating material such as plastic.

Each bolt can be in an electrically insulating position. In the electrically insulating position, the bolt prevents the associated electrical contact from being accessible to another electrical contact through the access. If a bolt is in its electrically insulating position, there can be no electrical contact to another electrical contact. The bolt must therefore be moved out of its electrically insulating position in order for another electrical contact to electrically contact the electrical contact belonging to the bolt. When a bolt is in its insulating position, it is passed through its associated electrical contact in the sense of the present disclosure.

The bolts can be moved independently of each other. However, the bolts can only be moved from the electrically insulating position to an electrically non-insulating position if the two bolts are moved together. Thus, if one bolt is pressed in the direction of its electrical contact, as seen from the outside, by means of a pin, the bolt cannot leave its electrically insulating position unless the other bolt is also pressed in the direction of its electrical contact at the same time. A child cannot, for example, move a single bolt by means of an electrically conductive pin in such a way that the child could produce an electrical contact to the electrical contact of the bolt by means of the pin.

An optical device may be provided to detect when only one bolt, as seen from the outside, is moved in the direction of its electrical contact. Through the optical device, a blocking element may be moved into a blocking position if the optical device detects that only one bolt is moved by pressing. In the blocking position, the blocking element prevents the bolt from leaving its electrically insulating position.

In one embodiment, a rocker is provided which can be pivoted by moving only one bolt. When the bolts are alternately moved back and forth, the rocker rocks. By rocker is meant an elongated object that can be pivoted and rock similarly to a rocker. The optical device may detect a pivoting movement of the rocker and then trigger the blocking. The rocker thus ensures that it can be reliably detected in a technically simple manner when only one bolt is moved.

Ends of the rocker may be rotatably connected to ends of the bolt so that the rocker is pivoted only when only one bolt is moved towards the non-isolating position.

Ends of the bolts may merely rest on the rocker, so that the rocker is only pivoted when only one bolt is moved towards the non-insulating position. This minimizes the manufacturing effort.

A central region of the rocker can be held by a spring. The rocker can be moved against the force of the spring in the direction of the spring. The rocker can therefore be moved both in a pivoted manner and without a pivoting movement in the direction of the spring. In addition, the rocker can subsequently be moved back towards the initial position by the spring. Through this, the bolts can also be moved back to the isolating position by the force of the spring. In this embodiment, a single spring is sufficient to allow a plurality of bolts to be moved back to the initial position.

The spring is an elastically deformable body. For reasons of stability, the spring preferably consists of metal. However, the spring can also be made of plastic, for example. A spiral-shaped spring is preferred, since this can be mounted and held particularly easily with little installation space. However, the spring can be leaf-shaped, for example.

In one embodiment of the electrical household appliance of the present disclosure, the bolts can be moved along the vertical when the electrical appliance is set up as intended. Desirable movements can thereby be advantageously supported by gravity. Undesirable forces due to gravity can be avoided.

In particular, the bolts can be moved vertically through an electrical shield. The electrical shield is part of the electrical insulation that protects against touching the electrical contacts. The electrical shield may be a housing of the electrical appliance, e.g., consisting of plastic.

In one embodiment, a spring may be provided for each bolt, each of which can move the associated bolt to the electrically non-insulating position and hold it in that position. However, compared to the preceding embodiment, this embodiment is associated with the disadvantage of having to use a plurality of springs.

A rod, i.e., an elongated object, may be connected to the rocker and may protrude from the rocker. Preferably, the rod protrudes from a central region of the rocker. When the rocker is pivoted, the rod is also pivoted. A pivoting movement of the rod may cause a switch to be operated. When the switch is operated, it may cause a blocking element to move to a blocking position. In the blocking position, the blocking element blocks the movement of a bolt out of its isolating position.

In one embodiment, the rod or an end of the rod can be pivoted to a blocking surface. Once the rod or its end has been pivoted to the blocking surface, the rod cannot be moved further out of its insulating position. The blocking surface is therefore a surface that prevents the bolt from moving out of its insulating position when the rod has been pivoted to the blocking surface. For manufacturing reasons, the blocking surface is preferably a planar surface that is flat and has no curvatures. However, the blocking surface can also be curved. This is a technically very simple and reliable way of preventing a bolt from being moved out of its insulating position.

In one embodiment, a step or indentation comprises the blocking surface. The step or indentation ensures in an improved manner that the rod pivoted to the blocking surface cannot leave the blocking position in an unintential or accidental manner. In particular, it can be avoided that the rod can be pivoted beyond the blocking surface. The step comprises a planar blocking surface and a further planar surface projecting therefrom. The further surface is generally perpendicular or at least substantially perpendicular to the blocking surface. An indentation means an inwardly curved shape.

In one embodiment, one bolt is connected to another bolt by a connecting element. The connecting element may be a rod, for example. By connection is meant a fixed connection. The connecting element may have been manufactured integrally with the bolts in one step, for example by plastic injection molding. The further bolt is part of an electrical insulation for a further electrical contact. This embodiment is of particular advantage if at least three current-carrying electrical contacts are to be protected from accidental touching by bolts, since the number of components and thus also the installation space can be kept particularly small.

A bolt is preferably connected to a guide element which is guided by a guide rail. The guidance of the bolt ensures reliable operation. The rail is preferably U-shaped in section. The guide element can then extend into the U-shape for guidance. Two opposing guide rails may be provided for each guide element to guide the bolt particularly reliably. The guide element can also be edged. The edging then forms a guide rail in the sense of the electrical household appliance of the present disclosure, since the edging guides the guide element.

The guide element may be a plate. A plate is particularly suitable for stable and uniform guidance by two opposing guide rails. In addition, a plate can provide a suitably low center of gravity in order to be able to guide a bolt attached to it. Bolt and plate are preferably manufactured integrally in one step, for example by injection molding. Bolt and plate may consist of plastic.

Preferably, a housing part consisting of plastic comprises the guide rail for the guide element and/or the access for each electrical contact. Such a housing part may be manufactured integrally, for example from plastic, for example by injection molding, which keeps the number of parts and thus the assembly effort and the installation space advantageously low.

Preferably, at least one further rod is attached to the rocker, which is held by at least one holding rail. The position of the rocker is thus stabilized. This serves to ensure operational safety.

Preferably, a half-shell is provided comprising the holding rail and/or a blocking surface and/or a holder for holding the spring. Such a half-shell can be integrally manufactured in one step. This can be done, for example, by injection molding. The half-shell may consist of plastic. The number of parts is thus advantageously minimized and, thus, also the assembly effort and installation space.

The electrical appliance is preferably a stand part of a mixer. A mixer in the sense of the electric household appliance of the present disclosure comprises, in addition to the stand part, a vessel in which a food can be prepared by heating and/or mixing. The vessel can be connected to the stand part. Subsequently, a food can be heated and/or processed with a mixing tool.

Stand part therefore means the part of a mixer which is provided for standing on a ground, for example on a worktop. A stand part may therefore have protruding knobs on its underside, for example. The vessel can be inserted into a recess of the stand part, for example.

The mixing tool may be present at the base of the vessel. The mixing tool may be connected to a shaft that passes through the vessel bottom. The shaft may be connected via a coupling to the shaft of an electric motor which is present in the stand part.

The vessel comprises a heating device and therefore electrical contacts for the purpose of power supply, which are to be supplied with power via electrical contacts of the stand part. The electrical contacts of the vessel are connected to the electrical contacts of the stand part when the vessel is connected to the stand part, for example when it is inserted into a recess provided for this purpose in the stand part. The electrical contacts of the vessel are usually electrical plugs. The electrical contacts of the vessel may protrude downwards from the bottom of the vessel.

In one embodiment of the electrical household appliance of the present disclosure, the electrical contacts of the vessel have different lengths. The length of the bolts is correspondingly different. If, for example, a right-hand electrical plug is shorter than a left-hand electrical plug of the vessel, then the right-hand bolt of the stand part is correspondingly longer than the left-hand bolt of the stand part. A coding can therefore be achieved by using bolts of different lengths and/or electrical contacts of different lengths. Safety against unintentional touching of contacts is thus improved. This applies, among other things, because non-coded third-party devices cannot be electrically connected to the electrical contacts of the stand part. This also applies independently of the stand part and the vessel. Two bolts of an electrical appliance are therefore advantageously of different lengths for coding reasons, in order to ensure that an electrical connection is only possible with accordingly coded, corresponding electrical appliances.

In order to be able to keep the installation space for the stand part of the mixer particularly small, the mixer is preferably designed such that the maximum possible rotational speed of the mixing tool at which the mixer can rotate the mixing tool is 1000 revolutions per minute. Preferably, the maximum possible rotational speed at which the mixer can rotate the mixing tool is no more than 400 revolutions per minute.

However, the mixer may also rotate at speeds of, for example, at least 5000 revolutions per minute, if it is not to be particularly small. To avoid overloading, the speed should not exceed 20000 revolutions per minute.

The present disclosure relates to an electrical connector of an electrical appliance for establishing an electrical plug connection. The present disclosure may therefore also relate only to an electrical connector of an electrical plug connection. Such a connector would then consequently comprise: electrical contacts, accesses to the electrical contacts for establishing an electrical plug connection, an electrical insulation which protects against touching of the electrical contacts, at least two bolts as part of the electrical insulation which are passed through the electrical contacts in an electrically insulating position, wherein the bolts can be moved independently of each other, wherein the bolts can be moved further from the electrically insulating position to an electrically non-insulating position only when the two bolts are moved together. Further, such electrical connectors may be configured as described above.

1. An electrical household appliance comprising:
electrical contacts,
accesses to the electrical contacts for establishing an electrical plug connection,
an electrical insulation which protects against touching the electrical contacts,
at least two bolts as part of the electrical insulation, wherein the at least two bolts are passed through the electrical contacts in an electrically insulating position, wherein the bolts are movable independently of each other, wherein the bolts are movable further from the electrically insulating position into an electrically non-insulating position only when the two bolts are moved together.

2. The electrical household appliance of claim 1, further comprising a rocker pivotable by moving only one bolt.

3. The electrical household appliance of claim 2, wherein ends of the bolts rest on the rocker.

4. The electrical household appliance of claim 2, wherein a central region of the rocker is held by a spring.

5. The electrical household appliance of claim 2, characterized in that a rod is connected to the rocker and protrudes from the rocker.

6. The electrical household appliance of claim 5, further comprising a blocking surface, and wherein the rod is pivotable to the blocking surface.

7. The electrical household appliance of claim 6, wherein an indentation or step comprises the blocking surface.

8. The electrical household appliance of claim 1, wherein a first bolt connected to a further bolt by a connecting element, wherein the further bolt is part of an electrical insulation for a further electrical contact.

9. The electrical household appliance of claim 1, wherein a first bolt is connected to a guide element guided by a guide rail, and wherein the guide rail is part of a housing part consisting of plastic.

10. The electrical household appliance of claim 9, wherein the guide element is a plate.

11. The electrical household appliance of claim 9, wherein the housing part consisting of plastic includes the access for each electrical contact.

12. The electrical household appliance of claim 2, wherein at least one further rod is attached to the rocker, and wherein the at least one further rod is held by at least one holding rail.

13. The electrical household appliance of claim 6, further comprising a half-shell including the holding rail and/or a blocking surface and/or a holder for holding the spring.

14. The electrical household appliance of claim 1, wherein the electrical household appliance is a stand part of a mixer.

15. The electrical household appliance of claim 14, wherein the stand part includes an electric motor and a control device for a heating device of a vessel which can be inserted or is inserted into a recess of the stand part.

16. The electrical household appliance of claim 1, wherein the at least two bolts of the electrical appliance have different lengths.
